(19) United States
(12) Patent Application Publication
(10) Pub. No.: US 2014/0222722 A1
(43) Pub. Date: Aug. 7, 2014

(54) Adaptive system for continuous improvement of data

(71) Applicants: Ajit Varma, Mountain View, CA (US); Tal Dayan, Los Gatos, CA (US)

(72) Inventors: Ajit Varma, Mountain View, CA (US); Tal Dayan, Los Gatos, CA (US)

(21) Appl. No.: 11/351,259

(22) Filed: Feb. 10, 2006

(51) Int. Cl. G06N 5/04; G06N 99/00

(52) U.S. Cl. CPC G06N 5/04; G06N 99/005
USPC 706/12

(57) ABSTRACT

Adaptive system and process for improvement of data. A first rules module applies one or more data accuracy rules to a data input to improve data accuracy of the input. A second rules module applies one or more meta rules while applying data accuracy rules, the one or more meta rules invoking another event to improve data accuracy.

### FIELD OF THE INVENTION

The present invention relates to improving the quality of the data input based on rules and adaptive meta rules.

### BACKGROUND OF THE INVENTION

Various systems exist for collecting data from different users such as resume uploading systems, survey response systems, contest entry systems, marketing database systems, surveying systems, etc. This collected user data may be used for one or more different purposes including data mining, reporting, analysis, decision support, planning and other suitable uses. Because this data often originates from different enterers, the accuracy of the data may vary widely from record to record. Some data may be completely accurate while other data ranges from slightly inaccurate to highly inaccurate depending largely on the data entry skills of the enterer. Inaccurate data can translate to poor decision making based on mistaken or even excluded data that may result in sub optimal performance of processes dependant on the data.

Strict data entry processes require a user to enter data in strictly formatted forms, even one field at time, with strict data validity. This type of process frustrates users due to the time involved. Automated data cleansing applies rules created by data experts in anticipation of entry errors and are used to automatically trigger corrections when particular character strings are encountered. This process often fails because the rule creator fails to anticipate all data conditions when creating the rules leading to incorrect or no corrections being made. Many processes thus rely on manual correction, which requires time and resources and is prone to operator error. Obviously, this is a labor intensive process and prone to errors by the operator.

The description herein of various advantages and disadvantages associated with known apparatus, methods, and materials is not intended to limit the scope of the invention to their exclusion. Indeed, various embodiments of the invention may include one or more of the known apparatus, methods, and materials without suffering from their disadvantages

### SUMMARY OF THE INVENTION

Accordingly, at least one exemplary embodiment may provide a method for improving the quality of data. The method may involve applying one or more data accuracy rules to a data input to improve data accuracy of the input and applying one or more meta rules while applying data accuracy rules, the one or more meta rules invoking another event to improve data accuracy. A system and computer readable medium may be provided that operate to perform these functions.

Yet another exemplary embodiment may provide a computer readable storage medium comprising computer readable instructions stored therein, the instructions adapted to cause a computer to perform an adaptive data improvement method. The instructions according to this embodiment comprise instructions for receiving a data input, instructions for storing the data input in a storage medium and for assigning an accuracy level to the data input, instructions for applying a rule set comprising at least one rule to the data input thereby performing a data clean up process on the data input, and instructions for invoking a meta rule when the rule set module is unable to correct a non-recognizable input of the data input.

These and other embodiments and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a exemplary schematic diagram of correcting data input in a system designed to receive and maintain data inputs;

FIG. 2 is an exemplary data accuracy diagram illustrating various levels of data accuracy in accordance with at least one embodiment of the invention;

FIG. 3 is an exemplary schematic diagram of an exemplary system architecture of a system for continuously improving the quality of data according to at least one embodiment of the invention;

FIG. 4 is an exemplary block diagram illustrating various components of server for use with a system for continuously updating s according to at least one embodiment of the invention

FIG. 5 is an exemplary flow chart detailing acts of a process for continuously improving the quality of input data according to at least one embodiment of the invention; and

FIG. 6 is an exemplary flow chart detailing acts of a process for updating a rule in the rule set with a meta rule according to at least one embodiment of the invention.

### DETAILED DESCRIPTION

The following description is intended to convey a thorough understanding of the embodiments described by providing a number of specific embodiments and details involving systems and methods for continuously improving the quality of data input based on a defined rule set and a set of meta rules which are applied to the data input thereby continuously and adaptively improving the quality of data. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs. According to one exemplary embodiment, a method for improving the quality of data may involve applying one or more data accuracy rules to a data input to improve data accuracy of the input and applying one or more meta rules while applying data accuracy rules, the one or more meta rules invoking another event to improve data accuracy. The data input may be stored prior to or after some data accuracy rules are applied. Input may be received in a number of ways including over a communication link, as an electronic file containing the electronic data, or in an electronic message, for example. The other event may include requestor operator (e.g., human or automated) correction (such as by selecting a correction to the data input).

Meta rules may determine that one or more of the data accuracy rules may not be operating effectively (e.g., the data is not recognized by the one of data accuracy rule). The data accuracy rules may automatically correct data input. The meta rules may determine when the data accuracy rule is unable to correct data input (e.g., because the data is not recognizable to the data accuracy rule).

An accuracy level may be assigned to the data input (e.g., after a data accuracy rule has been applied). At least one data analysis operation on data in the database having an accuracy level of at least a level determined to be acceptably accurate, including one or more of generating a report, determining a list of data inputs sharing a common component, and ranking a list of data inputs based on at least one operator selected variable and combinations thereof.

Data accuracy rules may evolve based on correction decisions (e.g., by updating one or more data accuracy rules based on actions taken related to one or more meta rules wherein updating may include adding a new rule, deleting a rule due to a discovered conflict or for other reasons, modifying an existing rule and combinations thereof).

System Overview

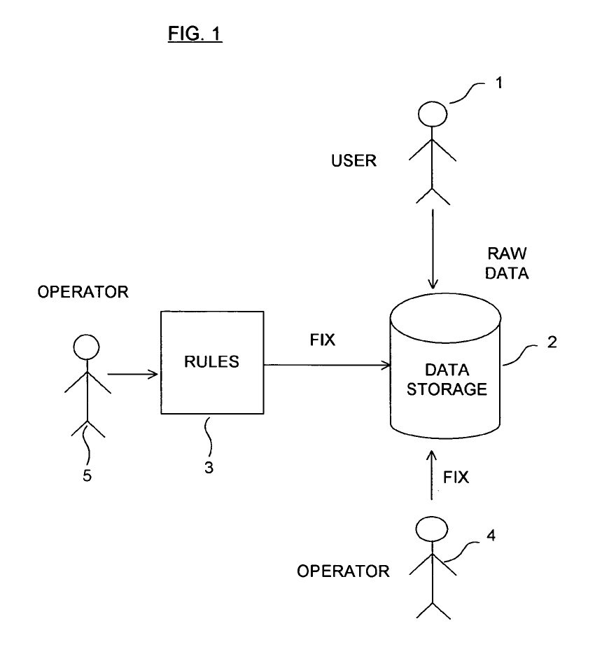

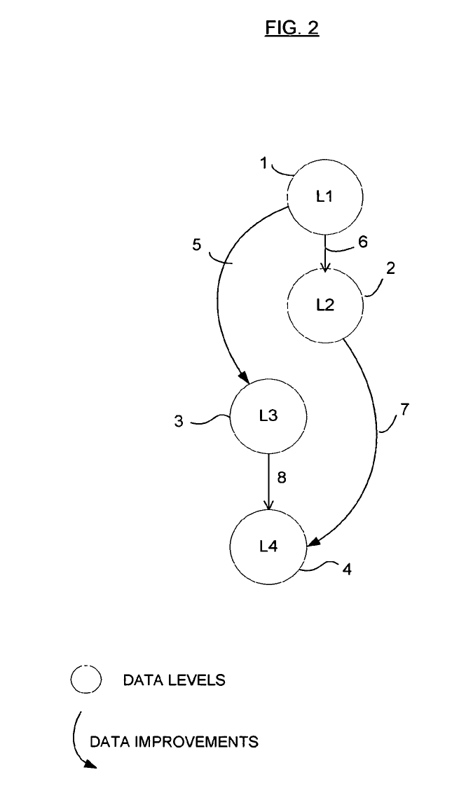

Referring now to FIGS. 1 and 2, exemplary systems for improving quality of data according to conventional techniques and according to systems and methods of the embodiments of the present invention are illustrated respectively. It should be appreciated that as used herein, the term “data input” should be understood to refer broadly to any type of data received including data submitted by a user electronically in a form, uploaded as an attachment through an Internet web page, attached to an email as a file and/or document, sent in the body of an email as text, output by a text to text or script to character recognition system such as an optical character recognition system, collected on behalf of a user, generated about a user, or collected or received in any other manner.

As used herein, the term “database,” should be understood to refer broadly to any data storage program and/or hardware including, but not limited to a relational database, a business intelligence system, a distributed database, etc., that can be a stand alone system or part of another system such as, for example, a web server.

As used herein, the term “operator” should be understood to refer broadly to a person associated with administrating the various systems and methods provided by the embodiments of the invention. As used herein, the term “user” should be understood to refer to an entity that relates to data input to the system.

FIG. 1 depicts three techniques for increasing data accuracy levels. The first technique is based on a strict data entry process whereby the user is enters data in strictly formatted forms, even one field at time, with strict data validity. Often pre-populated drop down fields may be used to increase accuracy. In FIG. 1, this technique is illustrated as user 1 inputting raw data into a data storage element 2. Because strict adherence to format and even field-by-field checks may be employed prior to data submission, data accuracy is improved relative to uploading a file in its entirely, such as, for example, a resume.

In the second technique, an automatic algorithm with built in rules that are used to “clean” the data. This technique is represented in FIG. 1 by rules 3 defined by operator 5 which are applied to the data in the data storage 2 to automatically “fix” the data input in the data storage unit 2. As noted, the rules used to correct are typically programmed by data experts in anticipation of entry errors and are used to automatically trigger corrections when particular character strings deemed to be “common mistakes” are encountered. After being entered by the operator 5, the rules are stored in the rule set 3. Thus, raw data entered by the user 1 that is stored in the data storage 2 is fixed in an automatic process by the rule set stored in the rules 3. The “fixing” operation may be performed at the time of entry, after submission, or at a later time in a batch mode. In this technique, less than optimal results may result if not all data conditions are anticipated when creating the rules and updates to the rules may be time consuming. The third technique depicted in FIG. 1 is manual correction. After data is entered by the user 1, an operator 4 manually fixes data by reading and/or formatting the hand through a completely manual word-by-word or field-by-field stepwise process.

FIG. 2 depicts various embodiments for providing a system for continuous correction of data inputs that is based on a multilevel rule set of rules and meta rules. Referring to FIG. 2, data inputs initially received by the data input system may be assigned an accuracy level of L1. In various embodiments, this may comprise data in its raw form, e.g., before error correction has been performed and/or completed. Here, the concept of accuracy may be understood as relating to the amount of errors and/or inconsistencies in an original in contrast to, for example, whether a received input was correctly received from a source (e.g., from an OCR-type system).

Four levels of accuracy, L1-L4 are depicted; although one of skill in the art should appreciate that increasing numbers may represent an increase in accuracy level. In various embodiments, more or less than 4 levels of accuracy may be used. Also, the number of accuracy levels and what they represent may vary depending on the design requirements of each system and type of data held therein. In various embodiments incoming data that has had no error correction applied to it may be assigned an accuracy level of L1. If, the system performs a correction operation on the data, such as by applying a base rule set to the data, the accuracy of the data may increase thereafter to L2 (level 2). In various embodiments, if a character string is discovered that is not recognized by the rule set but believed to be incorrect, a meta rule may then be invoked. The meta rule may cause a message to be sent to an operator, another system administrator or an automated system, alerting that entity of the character string and prompting the entity (e.g., the person or system) to make a correction. Based on suggestions by the meta rule engine or by personal knowledge or assistance from other connected systems, the user may correct the character string or override the rule so that the character string is accepted. The data input may be affected by the decision and therefore the accuracy of the data may be increased to L3 or L4. By increasing the data accuracy to levels L3 or L4, the data may now be eligible for inclusion in various data analysis and/or statistical reporting operations, for example, in a system in which less accurate data may excluded or may be included with reduced or different consideration. Generally speaking, at least up to a certain threshold, more accurate data (e.g., higher level data accuracy) is more useful to the entity maintaining it.

Exemplary System Architecture

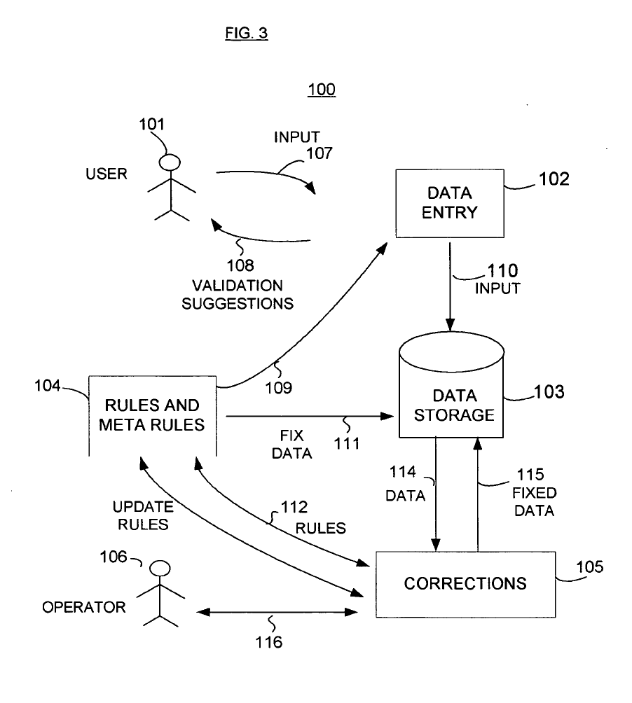

FIG. 3 depicts a schematic diagram of an exemplary system architecture of a system for improving (e.g., continuously) the quality of data according to at least one embodiment of the invention is depicted. The system may include one or more of the following elements: one or more users 101, data entry 102 received from one or more of the users 101, a data storage unit 103, a rules unit 104, including a base rule set and meta rules, an operator 106 and a corrections interface 105 through corrections are made to the rule set. A user 101 may provide data input 102 over input path 107. In various embodiments, rules from the rules unit 104 may be applied to the data input and the user may be prompted to elect one or more validation suggestions over path 108 based on a preliminary parsing of the data entry 102 in accordance with one or more rules in the rules unit 104. Also, the data input 102 may be stored directly in the data storage unit 103 over the input path 110 upon receipt from the user 101 (e.g., upon data input from that user). In such a case, the rules unit 104 may then perform a correction operation on the data input in the data storage 103 to check the data input for conformity with one or more associated rules and/or to check for non-recognizable character strings. In various embodiments, the rules unit 104 may apply fix data (e.g., instructions to fix detected errors) to the data input in the data storage 103. Also, in circumstances where the existing rules in the rules unit 104 may not be able to perform correction, rules unit 104 may invoke a meta rule. For example, a meta rule may exist for an non-recognizable character string. A meta rule may also exist for a character string that cannot be isolated to only one correction. It should be appreciated that a meta rule may also be triggered even where the existing rules are able to correct the data. In various embodiments, meta rules are “looking” for cases where operator intervention may increase data accuracy and/or consistency above the level of the existing rules. Numerous possible meta rules may exist. When a meta rule is triggered, a message may be sent to the corrections interface 105 to prompt operator 106 to perform a correction operation. In various embodiments, operator 106 may be supplied with the non-recognizable character string and an explanation of the meta rule that triggered the message. In various embodiments, operator 106 may make a selection and/or specify one or more correction operations through corrections interface 105. As noted herein, one or more correction operations may be to make a specific correction or even to ignore the current non-recognizable character string—that is, not to designate it as non-recognizable. Corrections interface 105 may correct the data in accordance with the correction decision and send the corrected data over path 115 to overwrite the data in the data storage 103. Also, corrections interface 105 may also update the rules unit 104 based on the correction decision so that future instances of the particular character string may be treated with a new or modified rule (e.g., without invoking a meta rule exception). In this way, the system may utilize operator input when the system is unable based on the existing rule set to improve the quality of the data input. Also, the rule set being adaptive improves its capabilities by incorporating correction decisions automatically into rules unit 104.

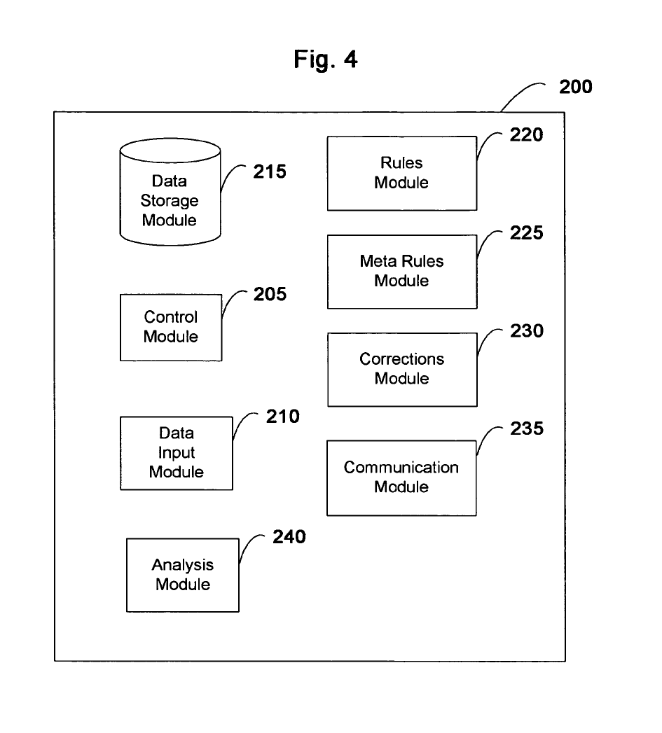

Referring now to FIG. 4 an advertising server for targeted marketing system based on an electronic billboard is illustrated in accordance with at least one embodiment of the invention. The server 200 comprises various modules, which may provide functionality that enables the system to continuously improve the quality of data stored therein or association, therewith. It should be appreciated that each module may be configured as a software application executing on computer hardware, an application specific integrated circuit (ASIC), a combination of hardware and software, or other suitable configuration. Moreover, modules may be combined or broken into multiple additional modules.

The server 200 may comprise one or more of the following: a control module 205, a data input module 210, a data storage module 215, a rules module 220, a meta rules module 225, a corrections module 230, a communications module 235 and an analysis module 240. The control module 205 may comprise a central processing unit CPU, a digital signal processor (DSP), an embedded processor or other suitable processing unit comprising hardware and combinations of hardware and software. In various embodiments, the data input module 210 comprises a module that receives data input, such as via an interface through which users of the system may be able to pass data inputs to the server 200, from data extraction or collection sources or other sources of data related to a user. The data input module 210 may comprise a web-based interface, an electronic mail interface, and an API interface that allows the server 200 to interface directly with a native application running on a client terminal. The data input module 210 may also be a connection to an OCR unit or other external or attached data input source or even other data sources such as separate external systems.

The data storage module 215 may comprise a computer hard drive, flash memory, holographic storage, or other storage medium. In various embodiments, the data storage module 215 may be located in association with the server 200. In various embodiments, the storage module 215 may be located remote to the server module and in communication therewith through the communication module 235. The communication module 235 may comprise a network interface card, modem, wireless transceiver or other network device and corresponding device drivers enable two-way communication between the server 200 and external devices and/or users. The communication module 235 may also facilitate interaction with other third party data systems that provide functionality or supply data input to the server 200.

The rules module 220 may apply one or more rules to data inputs to improve the quality of the data inputs. For example, the control module 205 may apply the rules in the rules module 220 to a data input in the storage module 215. The rules module 220 may then parse the data input to perform a data correction operation in accordance with any contained in the rules module 220. When one or more character strings are discovered that have a rule associated with it(them), the rules module may “fix” the character string in accordance with the procedure specified by the rule and the fixed string may be stored in the storage module 215. In various embodiments, the rules module 220 may not correct an otherwise non-recognizable string and meta rules module 225 may be invoked. It should be appreciated that the rules may not only search for specific character strings. The rules and meta rules may also search for and trigger based on more complex business logic and data rules. For example, in processing submitted resumes, the system may assume any date closest to a company name is an employment date or range. The Meta rules module 225 may alert an operator (e.g., through an interface included in the corrections module 230). In various embodiments, corrections module 230 may provide the operator with at least some portion of the data and may also provide information related to why the data was not corrected (e.g., the string was not recognized). For example, the data may include one or more words that are not included in a rule set, the data may include one or more words for which there are two competing corrections (e.g., each equally likely), or other such information. In various embodiments, the operator (e.g., a human or an automated process) may use the corrections module 230 to select one or more correction decisions. The correction may then be applied to the data and may then be stored in the data storage module 215. Also, the corrections module 230 and/or meta rules module 225 may update the rules module 220 based on the correction decision(s) and in so doing, future instances of the string may be handled in accordance with the correction decision, thereby effectively creating a new or modified rule.

In various embodiments, data inputs may be initially allocated a specific accuracy level upon being stored in the data storage module 215. After application of rules in the rules module and or the meta rules module 225, a higher accuracy level may be assigned to the data input. Moreover, after a data input is corrected through a correction decision made via the corrections module 230, another level of accuracy may be assigned to the data input and stored in association with the input in the storage module 215. The analysis module 240 may be used to perform various statistical and other reports on data inputs in the storage module 215 based on operator specified parameters, such as, for example, current assigned level of accuracy.

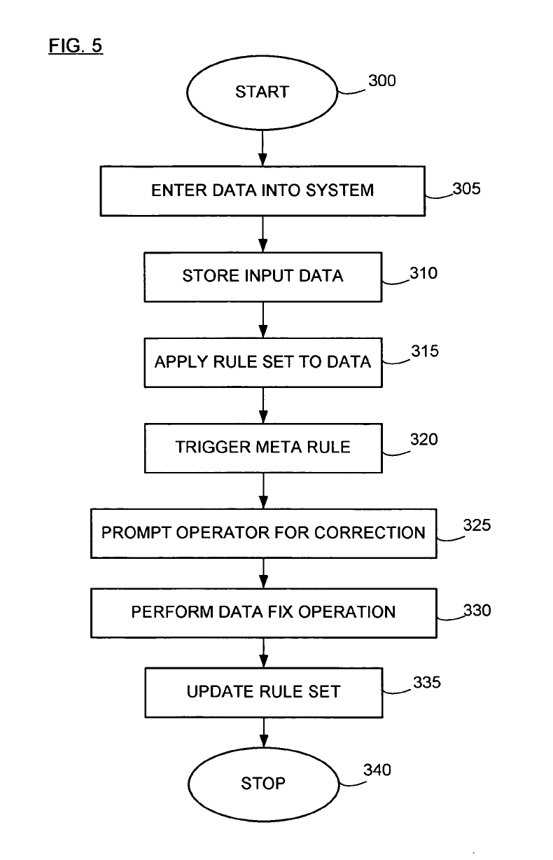

Each module depicted in the server 200 may operate autonomously or under the control of the control module 205 and/or one or more other modules. For example, in various embodiments, the control module 205 may be a CPU of a single integrated server 200. Furthermore, it should be appreciated that the particular modules illustrated in FIG. 5 are exemplary only and should not be construed as either necessary or exhaustive. In various embodiments, it may be desirable to use more, less or even different modules than those illustrated in FIG. 5. It should also be appreciated that the server 200 may also be configured as more than one server or a distributed network of servers and that the data storage module 215 may actually be one or more storage modules 215 located remote from the server 200 and accessible over a network so that each different storage module 215 may take advantage of the functionality provided by server 200. In various embodiments, processes for continuously improving the quality of data inputs may occur automatically, may occur after a certain number of data inputs have been received, may occur at certain discrete instances in time or may occur at operator request.

Exemplary Data Input Correction and Rule Update Processes

Referring now to FIG. 5, a flow chart detailing various acts of a process for improving (e.g., continuously) the quality of input data according to at least one embodiment is depicted. In block 300 the process commences. In block 305, a data input may be received by the system. As discussed herein, in various embodiments, this may comprise attaching a file to an electronic mail message, sending the data input as text in an electronic mail message, attaching the message through an Internet web page form, typing or pasting the data into a form field, sending the data input as a file through file transfer protocol (FTP), receiving the data input from an output device such as an OCR system, or receiving the data input from other sources or by other techniques. In block 310, the data input may be stored as input data. In various embodiments, this may comprises storing the data input in an electronic storage medium or in a database or other data structure. In various embodiments, this may also comprise assigning an initial accuracy level to the data input. In block 315, a rule set is applied to the data. In various embodiments, this may comprise parsing the data input string-by-string or character-by-character or both, to determine if there are any non-recognizable characters and/or strings that would trigger a correction operation based on an existing rule in the rule set. In various embodiments, if it is determined that non-recognizable characters and/or strings that would trigger a correction operation based on an existing rule in the rule set are present, such characters and/or strings may be corrected in accordance with one or more processes set forth in one or more rule sets. In various embodiments, after correcting any character(s) and/or string(s), a higher accuracy level may be assigned to the data input.

Block 320 may occur based on many events, including being triggered when a non-recognizable character and/or string is detected that may not be precisely corrected based on the existing rule set. In block 320, one or more meta rules may be triggered. In various embodiments, meta rules may exist as exception handlers when more than one correction may apply to a given character or string or when the character and/or string is suspected of being incorrect based on lack of conformity with existing knowledge base. In block 325, an operator may be prompted to make one or more correction decisions. In various embodiments, this may comprise presenting the user with a description of the meta rule(s) that triggered the prompt as well as a description of the offending character and/or string any other relevant information such as, for example, a list of two or more potential corrections for the offending character and/or string. In response to this, the user makes one or more correction decisions. In various embodiments, this may comprise the user specifying either through selection or explicit type entry, a character and/or string with which to overwrite the offending character and/or string.

In block 330, one or more of the data correction operation(s) selected by the operator may be applied. In various embodiments, this may comprise overwriting the data input in the data storage module or creating a new entry related to the original entry. In various embodiments, this may also comprise assigning a higher accuracy level to the data input. In block 335, the rule set may be updated based on the correction decision made by the operator. In various embodiments, this may comprise updating an existing rule, creating a new rule, creating a new meta rule and/or combinations of these. The method may terminate in block 340.

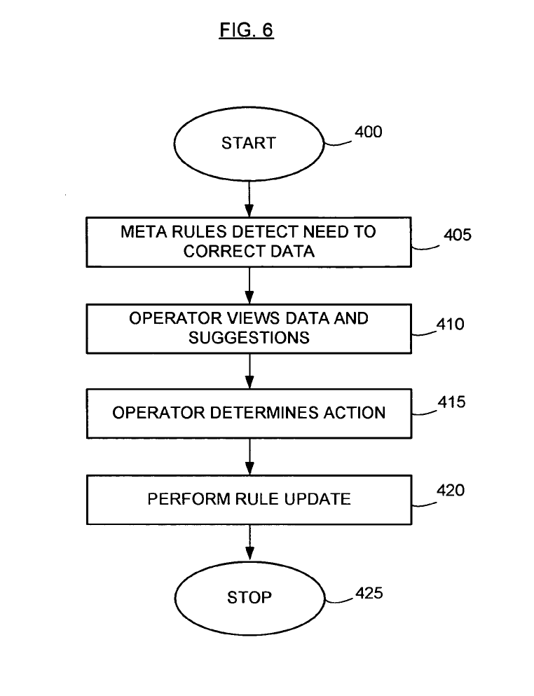

Referring now to FIG. 6, a flow chart detailing the acts of a process for updating a rule in the rule set with a meta rule according to at least on embodiment is depicted. The process begins in block 400. In block 405, the meta rules may detect a need to correct a data input. In various embodiments, as discussed herein, this may comprise determining that the existing rule set may not be ideally suited to correcting a particular non-recognized character or string (e.g., there is no current rule or the current rule fails to address one or more possible problems). In block 410, the operator may analyze (e.g., view or process) the offending character and/or string and may also view other relevant information provided by the meta rule including any suggestions for replacement of the offending character and/or string and what the nature of the offense is—i.e., are there multiple possible corrections, is the string and/or character simply unrecognizable, does the string and/or character violate a basic rule of the native language of the data input, etc. In block 415, based at least in part of the information provided through the meta rule, the operator may make a data correction decision by either selecting an appropriate action or explicitly entering one, such as replace with “_”. In block 420 information may be extracted from the operator's correction decision sufficient to create a new rule or rule modification. That is, in various embodiment, the system may recognize “when you encounter character or string “X”, act in accordance with decision “Meta_X.” In various embodiments, this may include recording a date and information identifying the operator in accordance with the actual correction decision. In block 420, the rule set may be updated based on the operator's correction decision so that future instances of “X” are handled in accordance with “Meta_X,” thereby effectively creating a new and/or modified rule in the rule set. In block 425 the process may terminate or repeat.

### Exemplary Embodiment

In one exemplary embodiment, the database may be an employer's database of resume belonging to persons interested in becoming candidates for employment with the particular employer. In various embodiments, users of the system, that is, persons wishing to submit their resumes for consideration may simply log onto a website associated with the employer or with an online employment searching website. In various embodiments, instead of requiring the user to enter their resume in a tedious field-by-field process, the user may be prompted to attach his or her resume by selecting a “browse” button adapted to let the user select a file on his or her client that contains the resume information in a previously specified format, such as, for example, a particular brand/version of word processor, field delimited text file, etc. Upon selecting a particular file and clicking a “submit” button, the data input in the form of a resume file may be uploaded to a computer server. In various embodiments, this resume may be stored in a data storage device and assigned a preliminary accuracy level, such as for example, a lowest level.

After storing the data input or resume file, the system may invoke perform an auto correction operation on the resume using multi-level rule set. If for example the resume contains date in the format “YY” rather that “YYYY” a rule in the rule set may change YY_ to 19_ or 20_ depending on whether the “YY” is <10 or >10. In another example, the user may have the character string Gooogle in a section describing his or her employment history. The rule set may already have a rule that specifies changing “Gooogle” to “Google.” If so, this change may be made automatically. After making this change, and any other changes specified by rules triggered in the rule set, the resume may be re-stored to include the text corrections. Furthermore, a higher accuracy level may be assigned to the data. However, if no existing rule in the rule set is designed to make this correction to the character string “Gooogle” and yet the parser recognizes that this is an offending string, a meta rule may be invoked. The meta rule may generate a message or alert to a designated operator alerting him or her that a meta rule has been triggered based on the inability to recognize the character string “Gooogle.” The operator may be presented with the offending string and prompted to perform and action such as, “ignore the string”, or enter an actual replacement string: namely “Google.” The meta rule or correction module then generates a rule based on the operator's elected course of action. Effectively, this creates a new rule such that future instances of the string “Gooogle” are replaced with “Google.” Moreover, this resume may be indexed in the data storage unit or database with other resumes listing Google in their list of previous employers. Moreover, a higher accuracy level may be associated with the resume so that the if an operator desires to perform a search of other analysis on resumes in the database, this resume may be included as having a sufficiently high accuracy level.

Thus, the various systems and methods for continuously and adaptively increasing the accuracy of data inputs to a data input system provide improved data accuracy and thereby more valuable data and decision making from the data.

It should be understood that the server, processors, and modules described herein may perform their functions automatically or via an automated system. As used herein, the term “automatically” refers to an action being performed by any machine-executable process, e.g., a process that does not require human intervention or input or only requires limited human input such as to execute the command to being the automated process.

The embodiments of the present inventions are not to be limited in scope by the specific embodiments described herein. For example, although many of the embodiments disclosed herein have been described with reference to advertisement messages, the principles herein are equally applicable to other documents and content. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

1. A method for improving the quality of data comprising:
storing a plurality of data inputs, including a first data input, in a computer-readable storage medium;
storing a plurality of rules and a plurality of meta rules in a rules database;
modifying one or more of the data inputs stored in the computer-readable storage medium by applying one or more of the plurality of rules to automatically improve accuracy of the one or more data inputs;
assigning to the one or more modified data inputs a first measure of data accuracy based on a first type of data correction associated with the application of the one or more rules;
identifying at least one deficiency in the plurality of rules;
applying one or more of the plurality of meta rules based on the identified at least one deficiency to invoke at least one event to modify the first data input in the computer-readable storage medium and thereby improve accuracy of the first data input;
assigning to the modified first data input a second measure of data accuracy, the second measure based on a second type of data correction associated with the invoked event and indicating a higher level of data accuracy than the first measure; and
modifying the plurality of rules stored in the rules database based at least in part on the modification to the first data input.

2. The method of claim 1 wherein the event comprises requesting operator correction.

3. (canceled)

4. The method of claim 1 wherein identifying at least one deficiency comprises identifying that the first data input is not recognized by the plurality of rules.

5. The method of claim 1 wherein the modified plurality of rules define a process to automatically modify another instance of the first data input and thereby improve the accuracy of the other instance of the first data input.

6-7. (canceled)

8. The method of claim 1, further comprising assigning a third measure of data accuracy to the unmodified first data input, the first and second measures each indicating a higher level of data accuracy than the third measure.

9. The method of claim 1, further comprising receiving the first data input prior to applying the one or more meta rules.

10. The method of claim 9, wherein receiving the first data input comprises receiving the first data input over a communication link.

11. The method of claim 10, wherein receiving the first data input over a communication link comprises receiving an electronic file containing the first data input.

12. The method of claim 10, wherein receiving the first data input over a communication link comprises receiving an electronic mail message and extracting data from the electronic mail message.

13. (canceled)

14. The method of claim 2 wherein the operator is a user.

15. The method of claim 14 wherein the at least one event to modify the first data input and thereby improve accuracy of the first data input comprises prompting the operator to select a correction to the first data input to produce the modified first data input.

16-18. (canceled)

19. The method of claim 1 wherein the event comprises an operator providing a correction decision for modifying the first data input.

20. The method of claim 1 wherein modifying the plurality of rules comprises performing at least one operation selected from the group consisting of adding one or more new rules, modifying one or more existing rules, deleting one or more existing rules, and combinations thereof.

21-22. (canceled)

23. The method according to claim 1, wherein storing the plurality of data inputs comprises storing the plurality of data inputs in a database, the method further comprising performing at least one data analysis operation on data in the database associated with a measure of accuracy of at least a level determined to be acceptably accurate.

24. The method according to claim 23, wherein performing at least one data analysis operation comprises performing a data analysis operation selected from the group consisting of generating a report, determining a list of data inputs sharing a common component, and ranking a list of data inputs based on at least one operator selected variable and combinations thereof.

25. A system comprising one or more data processors executing instructions to implement:
a rule set module adapted to apply one or more of a plurality of rules to automatically improve accuracy of one or more of a plurality of data inputs, the plurality of data inputs comprising a first data input;
a meta rule module adapted to identify at least one deficiency in the plurality of rules and to invoke at least one event to modify the first data input and thereby improve accuracy of the first data input;
an accuracy measure module adapted to:
assign to the one or more modified data inputs a first measure of data accuracy based on a first type of data correction associated with the application of the one or more rules; and
assign to the modified first data input a second measure of data accuracy, the second measure based on a second type of data correction associated with the event and indicating a higher level of data accuracy than the first measure; and
a rule modification module adapted to modify the plurality of rules based at least in part on the modification of the first data input.

26. A computer readable storage medium comprising computer readable instructions stored therein, the instructions adapted to cause a programmable processor to:
apply one or more of a plurality of rules to automatically improve accuracy of one or more of a plurality of data inputs, the plurality of data inputs comprising a first data input;
assign to the one or more modified data inputs a first measure of data accuracy based on a first type of data correction associated with the application of the one or more rules;
identify at least one deficiency in the plurality of rules;
apply one or more meta rules based on the identified at least one deficiency to invoke at least one event to modify the first data input and thereby improve accuracy of the first data input;
assign to the modified first data input a second measure of data accuracy, the second measure based on a second type of data correction associated with the invoked event and indicating a higher level of accuracy than the first measure; and
modify the plurality of rules based at least in part on the modification to the first data input.

27. A method for improving the quality of data comprising:
receiving a plurality of data inputs including a first data input;
storing the first data input in a computer-readable storage medium;
storing a plurality of rules and a plurality of meta rules in a rules database;
modifying the data inputs stored in the computer-readable storage medium by performing a data clean up process on the data first input, the data clean up process invoking:
the plurality of rules to automatically improve accuracy of one or more of the plurality of data inputs; and
at least one of the plurality of meta rules to identify at least one deficiency in the plurality of rules and to invoke at least one event to modify the first data input and thereby improve accuracy of the first data input;
assigning to the modified one or more data inputs a first measure of accuracy based on a first type of data correction associated with the invoked rules;
assigning to the modified first data input a second measure of accuracy, the second measure based on a second type of data correction associated with the invoked event and indicating a higher level of accuracy than the first measure; and
modifying plurality of rules stored in the rules database based at least in part on the modification to the first data input.

28. The system of claim 25 wherein the meta rule module identifies at least one deficiency in the plurality of rules by identifying that the first data input is not recognized by the plurality of rules.

29. The system of claim 25 wherein the rule modification module is adapted to modify the plurality of rules by performing at least one operation selected from the group consisting of adding one or more new rules to the rule set module, modifying one or more existing rules of the rule set module, deleting one or more existing rules from the rule set module, and combinations thereof.

30. The system of claim 25 wherein the at least one event comprises requesting operator correction.

31. The computer readable storage medium of claim 26 wherein identifying at least one deficiency in plurality of rules comprises identifying that the first data input is not recognized by the plurality of rules.

32. The computer readable storage medium of claim 26 wherein modifying plurality of rules comprises performing at least one operation selected from the group consisting of adding one or more new rules, modifying one or more existing rules, deleting one or more existing rules, and combinations thereof.

33. The computer readable storage medium of claim 26 wherein the at least one event comprises requesting operator correction.

34. The method of claim 27 wherein identifying at least one deficiency in the plurality of rules comprises identifying that the first data input is not recognized by the plurality of rules.

35. The system of claim 27 wherein modifying the plurality of rules comprises performing at least one operation selected from the group consisting of adding one or more new rules, modifying one or more existing rules, deleting one or more existing rules, and combinations thereof.

36. The method of claim 1, further comprising applying one or more of the modified plurality of rules to additional data inputs to automatically improve accuracy of the additional data inputs.
